(19) United States
(12) Patent Application Publication
(10) Pub. No.: US 2022/0405609 A1
(43) Pub. Date: Dec. 22, 2022

(54) METHODS AND SYSTEMS FOR BUSINESS ASSURANCE DATA PROCESSING FOR AUTOMATED STANDARDS FRAMEWORK INTEGRATION

(71) Applicant: Yardstick (PTE. LTD.), Singapore (SG)

(72) Inventors: Jeffrey Neil Farmilo, Singapore (SG); Stephen Laurence Williams, Singapore (SG)

(21) Appl. No.: 17/835,820

(22) Filed: Jun. 8, 2022

Related U.S. Application Data
(60) Provisional application No. 63/211,544, filed on Jun. 16, 2021.

(51) Int. Cl. G06N 5/02; G06N 5/04

(52) U.S. Cl. CPC G06N 5/025; G06N 5/022; G06N 5/046

(57) ABSTRACT

Methods, systems, and computer programs are presented for collecting and processing business assurance data using a Software as a Service (SaaS) system. The method includes receiving a request to access the SaaS system from a user. The method includes providing an interface by the SaaS system to a remote device of the user. The business assurance data is represented as items to be filled in via the interface of a provisioned framework. Frameworks are used by both private and governmental organizations to measure and qualify products and/or services of a vendor. The items received via the provisioned framework are mapped and filled into a plurality of target frameworks. The method includes generating a provisioned template representing items filled into the provisioned framework and generating a plurality of target templates corresponding to each of the target frameworks. The items filled in via the interface of the provisioned framework are automatically filled into the plurality of target frameworks. In one example, the mapping implements a matrix to program item relationships that enable the mapping of said items from the provisioned framework to each of the target frameworks.

### CLAIM OF PRIORITY

This application claims priority to U.S. Provisional Application Ser. No. 63/211,544 entitled “METHODS AND SYSTEMS FOR BUSINESS ASSURANCE DATA PROCESSING FOR AUTOMATED STANDARDS FRAMEWORK INTEGRATION,” filed on Jun. 16, 2021, which is herein incorporated herein by reference.

### BACKGROUND

### 1. Field of the Invention

The present embodiments relate to a Software as a Service (SaaS) products used for collecting business assurance data from vendors and transforming data into formats required by one or more industry and/or regulatory frameworks.

### 2. Description of the Related Art

Industry and regulatory frameworks are usually established to outline guidelines, requirements and best practices. And in the case of some Regulations, to aid an organization in demonstrating adherence to the law. Generally, organizations implement or adopt frameworks so both themselves and their vendors are assured to be following certain practices and are able to demonstrate adherence to the organization's regulatory requirements. If an organization wishes to adopt or consume a product or service from a vendor, the organization must consider the practices and process in place within the vendor to determine if the use of that vendor would negatively (or positively) impact the organization's compliance level or posture. Such organizations may utilize their own framework or may require vendors to adhere to an industry framework(s) in order to enable the organization to make a compliance impact determination. For a vendor, this process can be very time consuming, especially if the vendor wishes to qualify its services under more than one framework or against multiple organizations' internal frameworks.

For a vendor, it is important that all information is entered correctly and, in the format, required for the specific framework. If data is incorrectly entered or misunderstood, the framework will score the vendor as not satisfying one or more requirements to be certified to provide its service. For the organization needing to certify vendors, it is imperative that its vendors meet the qualifications required for providing their service. By way of example, a vendor may be a provider of a cloud service. If the vendor and/or software of the vendor does not meet a threshold level of compliance in a framework, that vendor's service may be considered less optimal for achieving specific business goals, may be considered to pose security risks, or may not meet a governmental requirement that the organization must follow or satisfy. If the vendor is providing services to a regulated entity, said entity is usually required to report their compliance levels against the regulation to the regulator. For these reasons, vendors not only affect their chances of being hired to provide a service or product, but their compliance or noncompliance in some aspects could negatively impact the regulated entity that hired the vendor.

Frameworks do help organizations manage and control vendors and their services, and they also provide organizations and agencies a common language that can be used by engineers, professionals and company officers. The standards defined in frameworks also provide information that can be used by auditors and third parties to assess what types of controls are used for product or service standards, security controls and security risks, and processes used for audits of an organization. In some cases, framework(s) assessment results can enable an organization to make a compliance impact assessment and determine if they need to report non-compliance to their regulator.

For a vendor, working with frameworks can be a burdensome task that is prone to entry errors and/or misunderstandings of requirements or needed information. Given the benefits of frameworks to organizations, more and more organizations and agencies will continue to adopt frameworks with specific and/or custom data requests. Consequently, vendors wishing to be certified to provide their services will be required to learn even more variations in data demands and understand unique differences when entering data. Under this construct, it is unfortunate that there will growing cases where vendors are not qualified to provide services in error, e.g., due to confused data input.

It is in this context that embodiments arise.

### SUMMARY

Systems, devices, methods, and computer programs are disclosed and relate to a Software as a Service (SaaS) system used for collecting business assurance data from vendors and transforming collected data into formats required by one or more industry and/or regulatory frameworks. For ease of description and reference, the SaaS system incorporating the disclosed inventive embodiments is referred to herein as “the Prism Service, or Prism.” As will be appreciated by those of skill in the art, the Prism Service is designed to increase buyer confidence by assisting vendors in collecting, maintaining and delivery of business assurance data to potential customers. These potential customers are the organizations, either private or governmental, that will rely on the entered data into their frameworks to enable their making a determination of compliance, purchasing the vendor's products and/or services, prior to consuming these products and/or services. That is, companies (e.g., consuming organizations) should not purchase a product or service until they have determined the impact that vendor creates on their compliance posture. Thus, consuming organizations must make careful decisions on whether to buy a product or service from a vendor, or else that consuming organization will be impacted in its rating or compliance to an entity or entities it supplies products or services.

One embodiment of the Prism system enables the use of a provisioned Framework which in turn, provides a single, consistent measurement against target frameworks. Such target frameworks include, e.g., industry and/or regulatory frameworks that require specific business assurance data. In order to achieve this measurement, the Prism Service and Framework use a “Matrix” to programmatically map responses between the Prism Framework (i.e., the provisioned Framework) and items within industry and/or regulatory frameworks (i.e., target Frameworks).

Using the Prism system, a customer (i.e., vendor) is able to respond to one Prism Framework and seamlessly receive templates for all of the selected industry and/or regulatory frameworks populated with the responses made to the Prism (provisioned) Framework. The ability to answer once and receive all selected framework templates (in addition to a Prism provisioned Template) represents significantly increased efficiency through eliminating duplication and bias. Through the use of an impartial Prism measurement, the service enables suppliers to efficiently provide the necessary visibility to potential customers of their product or service. This enables the customer to determine the impact on their regulatory compliance posture and increase (or decrease) their confidence in the vendor and a potential purchase/agreement.

In one embodiment, the Prism Framework is configured to grow by ingesting frameworks into a Prism Matrix. The Prism Matrix includes logic for managing relationships between a single Prism Framework and each of the industry frameworks already ingested. In one embodiment, a business (e.g., vendor) looking to measure compliance against some or all the Industry and Regulatory Frameworks contained within the Prism Matrix would only have to complete and enter items for the Prism Framework (i.e., provisioned framework), instead of having to complete and enter data for each and every target framework. Further, the repetitive nature of the process is prone to introduce entry errors and/or inconsistencies. The programmatic mapping architecture disclosed herein reduces such errors and uses logic for identifying the appropriate responses when populating entries of select industry and/or regulatory frameworks with responses collected via the one Prism Framework.

The process described herein is by way of example, and provides illustrative embodiments of the methods used to Find, Create and Maintain the processed correlations between the Industry and Regulatory Frameworks and the Prism Framework that are contained within a Prism Matrix and the computer implemented processes that consume these correlations.

The process detail contained in this disclosure is generic in the sense that it represents one embodiment of the methods and systems enabled by the Prism Service. It should be understood that equivalent methods and/or alternatives may be used to enable the disclosed functionality of the Prism Service, the Prism Matrix and the integration of additional industry and/or regulatory frameworks. With this in mind, the following description will provide numerous specific details in order to provide a thorough understanding of the present invention. It will be apparent, however, to one skilled in the art that the present invention may be practiced without some or all of these specific details. In other instances, well known process steps have not been described in detail in order not to obscure the present invention. By way of example, some sections will provide an introduction of the different component parts of the Prism Service to facilitate examples and understanding. The advantages described in this disclosure will become apparent from the following detailed description, taken in conjunction with the accompanying drawings, illustrating by way of example the principles of the disclosure.

In one embodiment, a method for collecting and processing business assurance data using a Software as a Service (SaaS) system is disclosed. The method includes receiving a request to access the SaaS system from a user. The method includes providing an interface by the SaaS system to a remote device of the user. The business assurance data is represented as items to be filled in via the interface of a provisioned framework. The items received via the provisioned framework are mapped and filled into a plurality of target frameworks. The method includes generating a provisioned template representing items filled into the provisioned framework and generating a plurality of target templates corresponding to each of the target frameworks. The items filled in via the interface of the provisioned framework are automatically filled into the plurality of target frameworks. In one example, the mapping implements a matrix to program item relationships that enable the mapping of said items from the provisioned framework to each of the target frameworks.

In some embodiments, the mapping implements a matrix to program item relationships that enable the mapping of said items from the provisioned framework to each of the target frameworks. For each item filled into the provisioned framework, access is made to the matrix that contains deductive reasoning logic. The access is by a rules engine that processes one or more tests using the deductive reasoning logic on the items filled into the provisioned framework before being filled into one or more of the plurality of target frameworks. The items entered into the plurality of target frameworks enable generation of respective target templates representing the items of the target frameworks.

In some embodiments, each of said target templates include reporting the total number of items populated with responses filled into the provisioned framework by the user and a breakdown of said responses by type. The user is a vendor providing said items related to a service or product, said target templates include reporting of a “Maturity Score” that provides information related to the quality of said item responses provided by the vendor.

It should be appreciated that the present embodiments can be implemented in numerous ways, such as a method, an apparatus, a system, a device, or a computer program on a computer readable medium. Several embodiments are described below.

### BRIEF DESCRIPTION OF THE DRAWINGS

The embodiments may best be understood by reference to the following description taken in conjunction with the accompanying drawings.

FIG. 1 illustrates an example of a Prism framework structure, in accordance with one embodiment.

FIG. 2 illustrates examples of a provisioned framework, e.g., Prism Framework, with corresponding sections and associated delegations, in accordance with one embodiment.

FIG. 3 provides an illustration of the example relationships, in accordance with one embodiment.

FIG. 4 illustrates an example of a workflow, in accordance with one embodiment.

FIG. 5 depicts an example process flow for the Prism Matrix to Ingest and Deliver a new Framework, in accordance with one embodiment.

FIG. 6 presents a validation flow, in accordance with one embodiment.

FIG. 7 illustrates a Many to One Relationship Prism maintains with most External (e.g., target) Framework Items, in accordance with one embodiment.

Other aspects will become apparent from the following detailed description, taken in conjunction with the accompanying drawings.

### DETAILED DESCRIPTION

The following embodiments describe systems, devices, methods, and computer programs for collecting and processing business assurance data using a Software as a Service (SaaS) system. The SaaS system is configured for industry and regulatory framework questions, and in particular, making the process of completing multiple frameworks more efficient. It will be apparent that the present embodiments may be practiced without some or all of these specific details. In other instances, well known process operations have not been described in detail in order not to unnecessarily obscure the present embodiments.

As mentioned above, aspects of the present embodiments relate to a SaaS product used for facilitating completion and entry of framework related data, and methods for optimizing how the entered data is understood and translated for re-entry into other target frameworks. Without limitation to uses of the disclosed features in any product that implements the claimed features, example discussion will be made in regard to a SaaS system referred to herein as “the Prism System, the Prism Service, Prism Framework, or Prism.” The SaaS system, in one embodiment, operates on one or more servers. The one or more servers are accessible over the Internet by one or more users of the SaaS system. In one configuration, the one or more servers are part of a cloud system. The cloud system can be installed in a single location, a single datacenter or in multiple datacenters around the world.

One embodiment of the SaaS System defines functionality for, enables the use of, a provisioned Framework. The provisioned Framework is also referred to as the Prism Framework. In one embodiment, the Prism Framework provides a single, consistent measurement against the industry and/or regulatory frameworks the business assurance data is tied to. In order to achieve this measurement, the Prism Service and Framework use a “Matrix”, e.g., a logic matrix to programmatically map responses of items (e.g., business assurance data and/or data) entered via the Prism Framework and items within one or more industry and/or regulatory frameworks. Using the Prism system, a customer (i.e., vendor) is able to respond to one Prism Framework and seamlessly receive templates for all of the selected industry and/or regulatory frameworks populated with the responses made to the Prism Framework.

In one embodiment, the Prism Framework (i.e., provisioned framework) is a model that is constructed to simplify the process of identifying and providing responses to Business Assurance queries (i.e., response data to items requested in a framework). The Prism framework is segregated into Sections which contain several Items that require a service user response.

The architecture of the Prism Framework and correction functionality solves many technical problems that static Frameworks have. Some of the advantages of the Prism Framework are that Prism Sections/Verticals are targeted at, and optimized for, Business Functions as opposed to a common Topic. Further, each Section has several Subsections or Domains that are a collection of Items that relate to a Specific Topic relevant to that Business Domain. And, domains and their contained Items may be duplicated between Sections with Business Function Specific/Optimized Wordings and Descriptions.

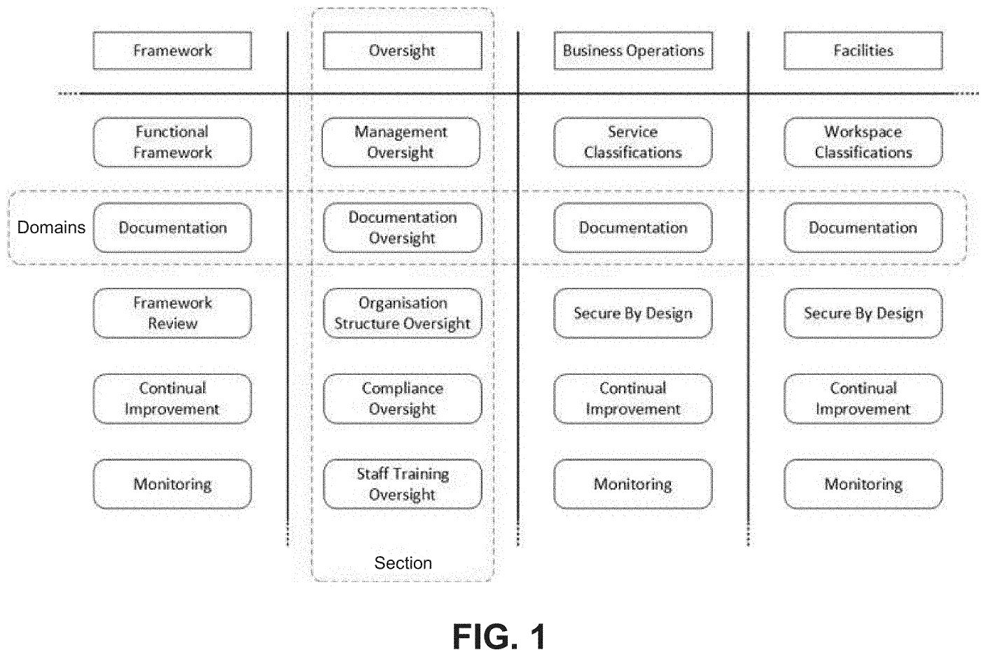

FIG. 1 illustrates an example of a Prism framework structure, in accordance with one embodiment. As shown, the framework is an engineered structured “Rubik's Cube” approach that enables highly detailed and focused reporting that can be by Section (Verticals), by Domains (Horizontals) or by a Specific Domain (e.g., the Intersection of a Vertical and a Horizontal). It should be understood that the example Prism framework structure is but one example, and more or less Sections and/or Domains can be added over time, and specific functions can be modified or referred to by different descriptive labels.

In one embodiment, a Reporting capability is designed to provide insights and visualizations of Framework Completeness, Incongruences, Scoring and Maturity. The example of FIG. 1 is only a snapshot of the Framework and does not represent the entire Framework.

Expanding on one counter-intuitive point, the SaaS system using the provisioned framework is able to deliver simplicity and efficiency, even when duplication within one target or base framework exists. In one embodiment, efficiencies come from the expected usage of the Prism Framework. By way of example, the provisioned framework is separated into sections that are targeted to specific business domains. Such as Business Operations, Technology Operations, Audit, Facilities Management and more. The expected usage of the provisioned Framework is to delegate each of these sections to the corresponding business domain. The provisioned framework also duplicates some topics between sections/business domains. Some examples of these include Business Continuity, Access Control and Documentation. Now, if a business has consumed the provisioned Framework, as intended, then the result will highlight incongruencies between business domains in the topics that have been duplicated. Without the provisioned framework, it is very inefficient to try and determine if (for example) the Technology Operations within a Business has Good Continuity Practices compared to the Facilities Management Domain in the same company.

In one embodiment, users of the Prism Service will include very small enterprises or even single operators all the way to large multinational enterprises. In small Enterprises, a Single user may be completing/responding to all the sections within an online interface that provides the provisioned framework of the SaaS system. In large enterprises, it is highly likely that the compliance team will need to delegate sections to specific business function owners and in turn their teams.

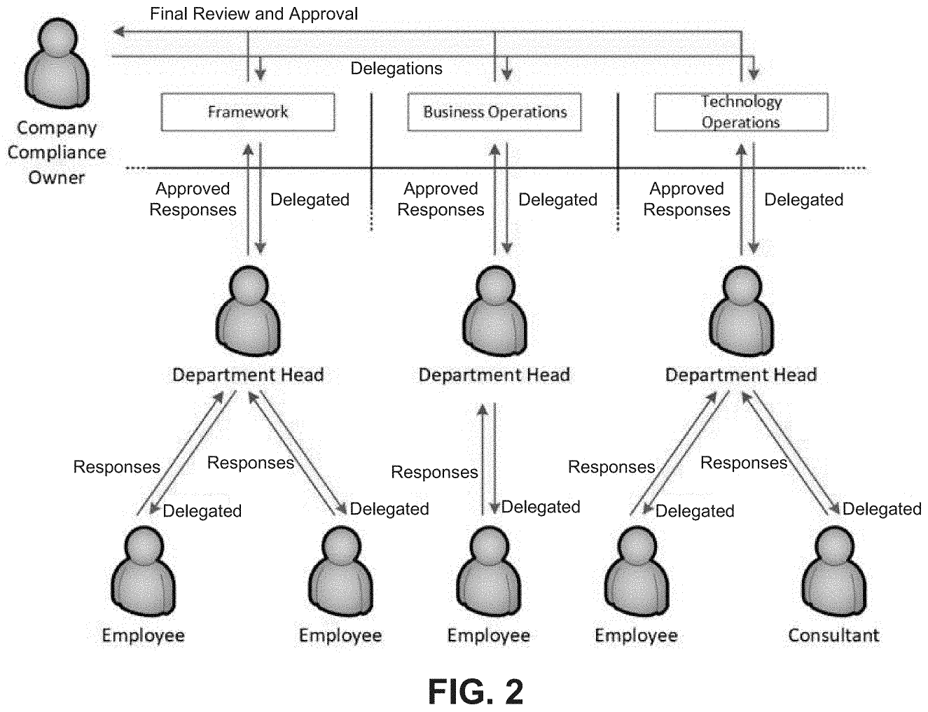

In the example case depicted in FIG. 2, Prism Framework Sections have been delegated to a Department Head or Executive and in turn, to a team a member(s) within that Department. Each time the Workload is Delegated, the Delegator is responsible to review and approve the responses. This is where duplication within Prism becomes necessary. At Review, the Approver is able to see Answers that are Inconsistent or Incongruous between the submissions. This also includes Answers between Business Functions during Review of Multiple Sections. Similar to the discussion above. Let's consider “Access Control”. This Topic is duplicated to most of the provisioned Framework Sections, because it is relevant to each Business Domain. Now, the Company Compliance Owner is able to see/measure compliance to their Access Control Requirements in some departments, but not others. The visibility into what aspects of the business conform to the Access Control Regulations and/or which managers/business domain owners have an incongruent picture of what the company actually does. Thus, the SaaS system enables intelligent removal of duplication of the External/Target Framework Themes, but it also duplicates some Prism/Provisioned Framework Themes across multiple Business Domains to identify inconsistent responses.

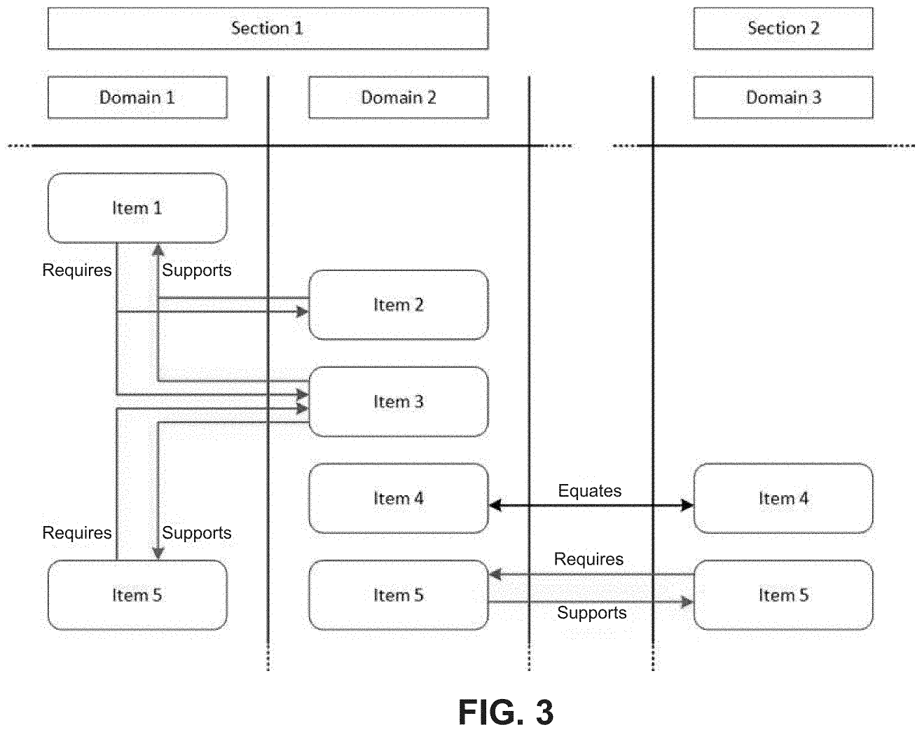

In one embodiment, the Prism Matrix is the Construct that informs the relationship between the provisioned Prism Framework and all external target regulatory and industry frameworks that have been imported or ingested and enabled by the Prism Service. One of the technical advantages of the Prism Service is the “Answer Once, Respond to Many” ability. In one embodiment, the Matrix and the Associations (described in FIG. 3) provided by the Prism Matrix are what enables Prism to provide its technical solutions. In one implementation, the Prism Matrix is defined in a database that contains all Prism Associations as Classifications.

It should be understood that Prism Matrix is not just a “join the dots” linkage between Framework Items, the Matrix contains the basis for deductive reasoning and applied computations, referred to and executed by the rules engine at a core of the Prism Software as a Service (SaaS) Platform.

While the Matrix contains the Framework data, its engineering enables the processing to hold and maintain all the Relationships and Associations, both internally within the Prism Framework but also with External Framework(s). By way of example, the Prism Framework has a human facing side which is what Humans Read and Interact with, and the Matrix is what provides the engineering logic and application of rules to render results provided by the Prism Software and Service.

In one embodiment, the Prism Matrix is engineered to follow the same logical structure, albeit in a very different data format, as the Prism Framework, and maintains the Sections that contain Domains with Items. In one example, each Prism Item can be related to other Prism Items for the purposes of Congruency and Consistency. In a specific example, the provisioned Framework is a set of questions that are split into sections that require responses. The provisioned Framework is held in a Database with a specific Data Structure. The Prism Matrix Database on the other hand has a similar data structure to the Framework Database but contains all the association and association requirements for the provisioned Framework items to the External/Target Framework Items. One process is configured to capture, store and process the matrix data in a different way to that of the provisioned Framework. But they are both Databases, just used in different ways. By way of example, the provisioned Framework is Engineered and Optimized to Contain the Question Text and Possible Response Values. The Matrix Data is Engineered and Optimized to contain and process Associations and Association Requirements between Items.

FIG. 3 provides an illustration of the example relationships. Internal Prism Relationships or Associations fall into the following three Categories:

Supports: This Prism Item Enables the Following Listed Prism Item(s) to be True or Partially True.

Requires: This Prism Item Can Not be True unless the Following Listed Prism Item(s) is also True.

Equates: This Prism Item is the Same as the Following Listed Prism Item(s).

Following on from the Relationships between Prism Items, any Specific Prism Item may be Associated or Mapped to Many External Framework Items. These Relationships are either Direct (a Mapping) or Indirect.

A direct Mapping is a direct correlation between a Prism Framework Item and an External Framework Item where the Prism Response and Associated Evidence is Provided to the External Framework is either the Response or part of the Response. An Indirect Association is where a Prism Framework Item is Required by another Prism Framework Item that has a Direct (Mapping) to an External Item. The Supporting (or Required Item) evidence and Response is not used to calculate the External Item, but influences the response.

The following are examples of the Prism Matrix Mathematical Models.

In one embodiment, the calculations Articulated by the Prism Matrix and Contained then Executed by the Rules Engine is Deductive Reasoning Mathematics. By way of introduction, the following example shows how Deductive Reasoning Mathematics differs from the more common Algebra which is essentially the basis for Calculus.

| With Algebra: | | |
|---|---|---|
| IF | 2 × b = 6 | |
| THEN | b = 6/2 | b = 3 |
| With Deductive Reasoning: | | |
| IS | b = 3 TRUE? | |
| IF | 2 × b = 6 | |
| AND | 2 × 3 = 6 | |
| THEN | b = 3 IS TRUE | b = 3 |

The objective of this example is to demonstrate that deductive reasoning, in accordance with one embodiment, is a True/False test and it requires a question to solve. In the case above, without the question that “b” might equal three (3) the process cannot start. Solving for the value of “b”, is not really the domain of Deductive Reasoning. This distinction is also important as the Prism Models are not able to determine, in isolation, what the “Correct” response actually is, only if the sum of the User Inputs/Responses is True or False.

Continuing this Example, in the case of the Prism Service, the provisioned Framework captures what “b” might be equal to, by prompting for user input. The deductive reasoning logic, the “IF” and “AND” Statements in the equation are contained within the matrix and constructed within the rules engine. The rules engine then performs the test to determine if the provided Value of “b” is indeed True, or False.

Therefore, deductive reasoning, as used in the present implementations use the logic from the matrix to make determinations of true or false. In contrast, there are other applications of deductive reasoning, which do not work to arrive at a true or false solution. By way of example, citing an example from California State University (csun.edu) for Chemistry, an element classification may use deductive reasoning to make an inference. However, the inference does not apply logic to arrive at a true or false. The California State University example proceeds as:
First premise: Noble gases are stable.
Second premise: Neon is a noble gas.
Inference: Therefore, neon is stable.

In accordance with one embodiment, the deductive reasoning used in the embodiments would proceed as:
IS: Neon Stable?
IF: Noble Gases are Stable
AND: Neon is a Noble Gas
THEN: Neon is Stable IS TRUE

It should therefore be understood that although deductive reasoning is used, its application in the context of processing entries/items of one framework to then complete or not complete entries/items in another framework utilize the additional processing to determine whether something is true or false. By way of example, if something is true, then the association is a valid outcome. In application, whether an item is true or false is a Statement of Compliance: e.g., Fully Compliant, Partially Compliant, Not Compliant or Not Applicable, etc.

Again, the deductive reasoning tests are about determining the valid outcome for an association. If a Target Framework Item is Directly Associated with two Provisioned Framework Items, then the Deductive Reasoning will show what response to the External Framework is Valid. A Simplistic (True/False) Example:

IS a Response to the External Framework Item of Pass Valid?

IF the Response to Provisioned Framework Item One is a Pass?

| | |
|---|---|
| 0. | True |

AND the Response to Provisioned Framework Item Two is a Pass?

| | |
|---|---|
| 0. | True |

THEN the Response to the External Framework Item is Valid.

| | |
|---|---|
| 0. | True |

This example is fairly straightforward when considering a response option of True or False. Where the Deductive Reasoning Validity Checking is unique is interpreting the impact of Responses like “Partially Complies”. While one External Framework might enable a Response of “Partially Complies” another may not. Therefore, what the Valid interpretation of the Response to the Provisioned Framework is in the context of a Particular External Framework is the Deductive Reasoning. This process is not able to determine what the “Correct” response for a particular user should or should not be in any situation. It can however suggest to the user that a Response of “Fully Compliant” would be Incongruent with a Previous Associated Response “Required” by this Item was provided as “Not Compliant” and therefore a Response above “Partially Compliant” is unavailable.

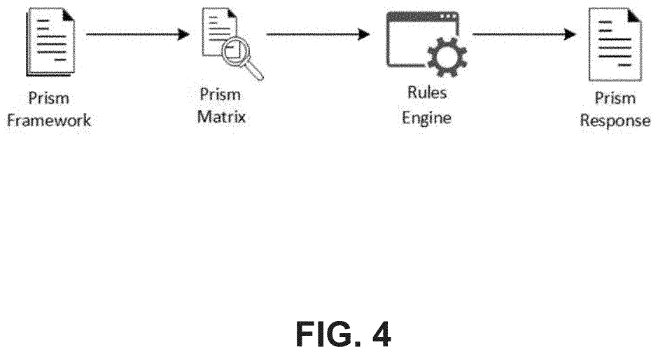

FIG. 4 illustrates an example of a workflow, in accordance with one embodiment. There are significant workflows and user-process management, as well as consumer/customer management processes within the Prism Service. This ancillary and supporting processes facilitate the consumption of the Prism Application and Matrix and do not directly influence its ongoing development. With reference to FIG. 4, the following components include:
Prism Framework: Question(s)
Prism Matrix: Framework Associations and Mathematical Test(s)
Rules Engine: Mathematics Execution
Prism Response Store: Rule Result(s)

The simplified process depicted in FIG. 4 is designed to demonstrate how a Customer Response to a Prism Framework Item flows through the Prism Service. It is not a complete representation of the Service. For each Prism (provisioned) Framework Item, all the Requirements and Associations for that (and all other) Items are contained within the Prism Matrix. The Rules Engine takes the Response to the Framework Item and the Deductive Reasoning Tests from the Prism Matrix and Performs the Calculation and Populates the Response within the Response Store.

There are several reasons for the separation between (in technical terms) Business Logic and Logic Execution including, amongst others, processing efficiency and scalability. However, the reason for this separation is the Review Process Described in later sections of this disclosure. In one embodiment, deductive reasoning logic that is part of the matrix is separate from execution of the deductive reasoning logic by the rules engine. In this manner, any modification to the deductive reasoning logic does not affect or change (i.e., is independent of) the execution of the rules engine.

In one embodiment, the Prism Service is about simplifying Business Assurance Data Collection and Distribution. Because the Prism Framework is not and cannot directly reproduce External Framework Items for multiple reasons, copyright included, Prism must provide assurance to customers and consumers of the Prism Service that the Associations are valid and all produced Framework Responses can/will withstand Legal Challenge. Hence, every and all Prism Framework Item Associations may be Reviewed and Approved by Industry Specialist Legal Counsel. In one embodiment, the legal validity of a Prism Association between one or more Prism Items and an External Framework Item is dependent on the Association being Static. Approval cannot be granted to a moving target, which in this case is the Application Execution code. Thus, in one embodiment, this is the reason for the Matrix being static and separated from the Rules Engine Application Execution code. In one embodiment, Prism is able to mature and optimize the Rule Execution through a process of continual improvement while maintaining a highly controlled and stringent approval process for changes to the Matrix.

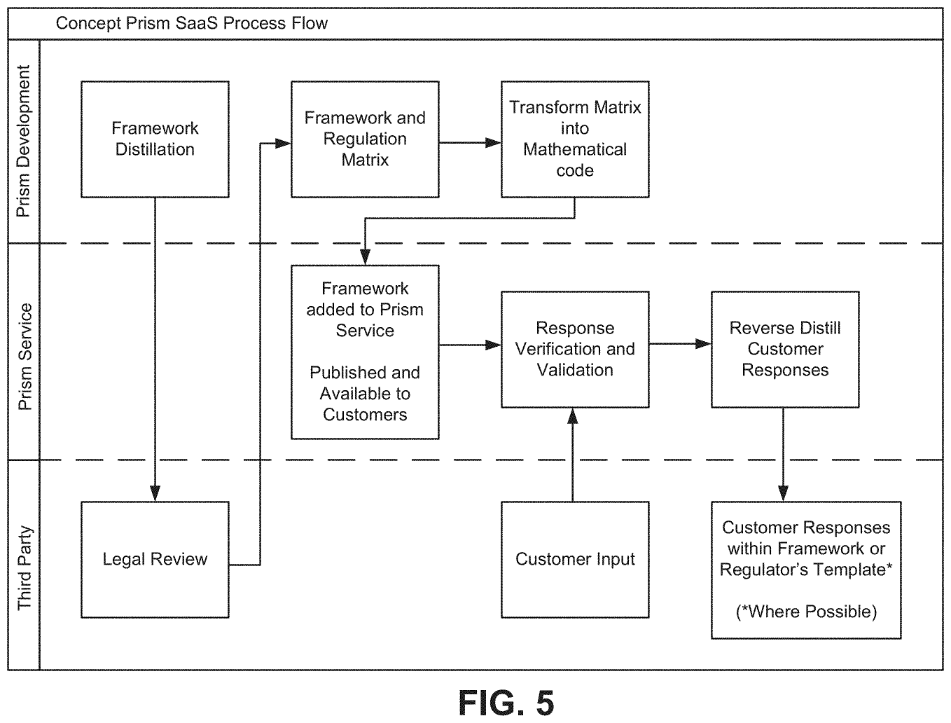

FIG. 5 depicts an example process flow for the Prism Matrix to Ingest and Deliver a new Framework, in accordance with one embodiment.

The Stages within the in the Flow that are described in the following sections are: Framework Distillation; Legal Review; Transform the Matrix into Mathematical Application Code; Incorporate the New Framework into the Prism Service for Customers; Verify and Validate Prism Customer Input; Reverse distill Prism Customer Responses. In one embodiment, the process requires inputs from outside of Prism Service to complete. These inputs include Legal Review and Validation of Associations, and Customer Responses.

In stage one, Framework Distillation is described in accordance with one embodiment. Frameworks both Regulatory (Example: Monetary Authority of Singapore (MAS) Outsourcing Checklist) and Industry (Example: Payment Card Industry Data Security Standard (PCI DSS)) are analyzed in significant detail and common themes, interdependencies and/or interrelated items can be identified. This process initiates as-and-when a new Framework is identified as a candidate for ingestion by the Prism Service. The example steps of the Stage One Process are as follows:

1. Analyst identifies and groups common Themes. Examples of common Themes in a Framework would be Data Protection, Risk Management, Business Continuity and Operational Oversight.

2. Analyst identifies Interdependencies within the Themes. An example of an Interdependent and/or Interrelated item could be Encryption within the context of Data Protection. It is difficult to prove real and/or robust Data Protection capabilities and/or processes if data is not encrypted. Hence, there is an interdependency between Data Encryption and Data Protection.

3. Analyst classifies the Interdependencies and Interrelationships. Continuing the example of Encryption from Step Two (2) above; Data Encryption at rest, supports Data Protection and Data Protection relies upon (or should include) Data Encryption. This classification is the basis for the Application Development contained in Stage Three (3). Items may also be classified as Inapplicable. Themes that fall into this category are Definitions or Items Not Intended for Non-Government Entities, as is the case within the European Union (EU) Personal Data Protection Legislation (GDPR).

4. Analyst identifies and associates (where possible) specific Theme Items from Step One (1) with a Prism Framework Item(s). Specific Framework Items within a given Theme are associated with specific Items within the Prism Framework. If the Prism Framework does not contain an appropriate and/or accurate representation of the Framework Item, then a new Prism Framework Topic and Question is developed to hold the Association(s). The same Framework Item may be associated with multiple Prism Items within different sections or with different classifications.

5. Peer Review is processed. In this step, processing of Peer Review of the specific Associations made by the Analyst and any proposed additional Topic(s) and/or Item(s) is completed. This review aims to validate the completeness and accuracy of the Association and Classifications. Following the peer review, the product owner (or delegate) formally approves the complete Association List. Stage one completes when the proposed changes to the Prism Framework and the Associations with the New Framework are finalized and approved. This also represents the Draft changes to the Prism Matrix. The Prism Matrix is the Database that contains all Prism Associations as Classifications. In one embodiment, Relationship(s) is a Generic Statement of an Association.

An Association within the provisioned Framework is any of “Supports”, “Requires” or “Equates”, between provisioned Framework Items. A Mapping is a “Direct Association” and possibly some “Indirect Associations” to a target Framework Item. By way of example, a target Framework Item Requires: “All Remote Access to Corporate Systems uses Multi-Factor Authentication to Validate Access Requests”. This can be referred to as Framework One Item 1.1. The provisioned Framework may have the following example Questions. The digits used in this example are not specific, and only used for purposes of providing an example.

### 7.4.1—Document all Network Access Standards and Policies

### 7.4.2—Document all Network Access Process and Procedures

### 7.4.3—Require Multi-Factor Authentication for Remote Network Access

The provisioned framework Associations will be:
7.4.3 is “Associated” with 7.4.2 and 7.4.1 with “Requires”
7.4.1 and 7.4.2 are “Associated” with 7.4.3 with “Supports”

With the above construct in place, if a company Policy about Network access is not provided, then you should not enforce Multi-Factor Authentication for remote access. The Standards and Procedures Documents (7.4.1 & 7.4.2) “Support” the Specific Question about remote access in 7.4.3. In the SaaS system provisioned framework, the user needs to say “Yes/Compliant” to 7.4.1 & 7.4.2 before any response can be given to 7.4.3 because the first two support the third and the third “Requires” the first two.

Continuing with the above example, the Relationship for these provisioned framework Items to items in target frameworks may be as follows. Framework One Item 1.1 is “Mapped” to 7.4.3. This is a “Direct Association” as the target Framework Item is Exactly the Item in Prism, i.e., the provisioned framework. The two Items that “Support” 7.4.3 or are “Required” by 7.4.3 are “Indirect Associations” to Framework One Item 1.1. In this case the Mapping/Direct Association between the Item 1.1 and 7.4.3 is recorded in the Matrix Explicitly and the Indirect Mappings are Calculated rather than being Captured/Recorded.

In one embodiment, therefore, Association Classifications of “Supports”, “Requires” or “Equates” apply to the Provisioned Framework Items. The Classification of “Direct” can apply to any item in Any Framework.

In one embodiment, Stage Two includes Legal Review. As one of the methods used by Prism to drive efficiency in the Business Assurance Process is to consolidate and/or distill Questions from External Frameworks, as described in Stage One (1) above, the accuracy of the associations within Prism are paramount. As a result, all Prism Associations are verified by external legal counsel with specific domain and/or jurisdiction knowledge of the Source Framework. In one embodiment, the technical solution and engineered processing provided by the Prism Tool is not dependent on legal review, but instead, legal review is used to verify the associations made between the Prism Framework to the target framework. In other words, the legal review is described herein for completeness to show how the associations are following the required format and content required for the target framework that was ingested for population by the Prism system.

1. Legal Counsel Selection

The principal Requirements for selection as Legal Counsel for a given Framework are:
a. Specific subject matter Expertise and Experience
b. Specific jurisdictional Expertise and Experience
   i. As necessary, for a specific Framework and/or language translation
c. Legal Firm must be well regarded either internationally or within the specific jurisdiction

The required skill set may exist within the existing legal partnerships or may require a new agreement. In the case of a New Agreement or Contract, some training and/or knowledge transfer of the Prism Framework may be required.

2. Legal Counsel Submission

The associations from Stage One (1) are provided based on the Source (New) Framework, not Prism. The format for each Item in the Framework being:
a. Source Framework Item—Section Number and Text
b. Prism Target Item Association—Section Number and Text
   i. Association Classification
c. Prism Target Item Association—Section Number and Text
   i. Association Classification
d. . . . and so on . . .

In the case where there are not multiple associations within the Prism Framework, Item “c.” onward from the above example, are not provided.

3. Legal Counsel Response

While the Process may require a degree of engagement between an operator of Prism and the legal counsel, the targeted outcome of the Review is as follows:
a. Source Framework Item
b. Prism Target Item Association—Agree or Disagree
   i. Association Classification—Agree or Disagree
c. Prism Target Item Association—Agree or Disagree
   i. Association Classification—Agree or Disagree
d. . . . and so on . . .

In the Case of a Disagree:
a. Justification
   i. Recommendation—Any or All of:
      1. Suggested New Prism Item and Text
      2. Suggested different Prism Item
      3. Suggested different Classification that may include Inapplicable

Stage Two (2) completes when the Final Legal Review Response is received by the operator of Prism, or an entity that uses the embodiments described and claimed herein. In the case where not all associations are agreed by the Legal Counsel, the process returns to Stage One (1) and ultimately resubmission(s) to the Legal Counsel until all the Associations for the new Framework are approved.

Upon receipt of the Formal Agreement to all Associations by the Legal Counsel, the draft changes to the Prism Matrix can be approved by the Prism Product Owner and the Process Proceeds to Stage Three (3).

In accordance with one embodiment, Stage Three (3) is processed. In stage three, an example transform the Matrix into Mathematical Application Code is discussed. Stage Three (3) represents the formal start of traditional Application Development. Prism Application and Service Development differs from most other application development processes, in that the Data Construct is created first. In one embodiment, a technical advantage provided is that the Data Construct (Prism Matrix) exists prior to Application Development, the opportunity of failed or incorrect Associations is practically eliminated. Testing Cycles are also able to be effectively Automated as the answer is known before development begins. This testing methodology is formally known as Test Driven Development.

In one embodiment, testing includes:
1. Writing the Application Tests.

In keeping with the Test-Driven Development Process, before Application code is written, the outcome that code needs to provide are written as Application Tests.
2. Create additional Prism Items.

Any additions or changes to the Prism Framework are written into the Matrix and corresponding Service Code.
3. Import the new Framework.

Create Framework Specific functions as necessary. Specific Framework Functions would include unique Application screens and/or processes such as Framework document generation.
4. Convert the new Associations into Mathematics.

While Step One (1) and Two (2) are necessary foundation Items, this Step is where the New Framework effectively becomes part of the Prism Service.

In one embodiment, the Deductive Reasoning Mathematics is in two parts; the Test and the Execution. As Deductive reasoning requires a Test to be validated before it can begin, the Test and all the Requirements for the Test reside within the Matrix. These Tests are the Approved Associations. Each Association created within the Prism Matrix has a set of requirements that form the basis for the rules constructed and executed within the rules engine.

In one embodiment, the SaaS system Separates Logic from Execution. In the Matrix there is a Test to Validate the Response for Three Different Prism Items for an External Item (e.g., item of a target framework). This Logic is Static and Gated with Legal Validation. The Rules Engine then takes this Requirement from the Matrix and performs the Validation of the Three Required Prism Items and Calculates the Response to the External Framework Item. This does indeed handle the “test” twice, but the reason for that is the Matrix only ever changes when there is an “Approved” Mapping. The Rules engine is application code that can change and evolve with time to be more efficient or more secure. From an audit perspective, it is then crystal clear that we only ever Calculate Associations from the Matrix and can clearly show that the Matrix doesn't change with each software update, unless there are new mappings.

As an Example, a new Association for a Prism Item is required by the External Framework being ingested. The Prism Item would have;
a. The Association(s) Specified
   i. External and/or Internal
b. The Requirement(s) for the Association(s) Specified
   i. Possible Values (True/False or Statement of Compliance such as “Fully Compliant”)
   ii. Calculation Logic such as:
      1. Sum of all associations
      2. Minimum or Maximum Score
         a. If any Association is a “Not Compliant” this response can not be “Compliant”
      3. Average Score
      4. Single Component Pass
         a. If any Association is “Compliant” this response can be “Compliant”
c. Available Data Fields
   i. If the new External Framework has a Response Template, list of what input fields are available.
      1. Such as Evidence (Document Links) or Comments

The Matrix contains the Deductive Reasoning Tests in a format far more human readable than within the Rules Engine where the format of the constructed rules is in equation form. Regardless of the format, the process of a Prism User providing a Response that is evaluated by the Tests stipulated by the Matrix, by the Rules Engine remains.

In one embodiment, these Rules are a core implementation of the Prism Service and the Rules to ensure both specific Process Flows for Users, including the Response Validation as is described in Stage Five (5) and the Reverse Distillation of Frameworks in Stage Six (6).
5. Service Testing Embodiment.

In one embodiment, the Application Tests from Step One (1) are then executed against the Application Code and underlying rules. The testing process is then repeated by humans, to ensure that the automated testing did not yield any false positives. Human testing is also more destructive and designed to attempt to use the Application and Service in ways other than those intended. Testing also involves Operational Testing where the process of promoting the Code into a Production equivalent is validated and tested. In one embodiment, the goal of Testing is to validate that all Code and Rules reflect the Legal Agreements from Stage Two (2). The final step in this Stage is the Formal Signoff from Testing, QA, Technical Operations and Product Owner.

In accordance with one embodiment, a Stage Four (4) is processed to incorporate the New Framework into the Service for Customers.

The first Step in the Process is the promotion of the Application and Service Code into production. This requires the formal signoff from Testing, QA, Technical Operations and Product Owner as detailed in Step Five (5) of Stage Three (3) above.
1. Promote Approved Code into Production.

The act of Promoting the Application and Service Code into Production makes the New Framework available to Customers.
2. Customer Service Consumption.

After the New Framework is available for Customer use. If any new Prism Framework Items have been added, these will prompt for user input. Users are also able to request reports that map their existing responses to the New Framework(s). In one embodiment, any new user input is now parsed by the updated Rules that contain the Conditional Statements as referenced by the New Frameworks.

User input to each Prism Item is captured in the following format:
a. User ID—User submitting the Response
b. Date—Date User made the Response
c. Response—User Answer to Prism Item
   (Service Rules may not allow all options available to all Items)
   i. Fully Complies
   ii. Partially Complies
   iii. Does Not Comply
   iv. Not Applicable
d. If the Response is other than “Does Not Comply” or “Not Applicable”
   i. Document Title—Document that contains evidence for compliance
   ii. Document Version—The version and/or date of the said document
   iii. Section—Location within said document
e. User Comment:
   i. Comment Text
   ii. Optional Document Association (as detailed above)
f. Externally Validated (Yes/No)—Was the above Response validated/audited externally?
   i. If Yes
      1. Company that performed this validation
      2. Date this validation/audit occurred
      3. Document Title—the Report containing the evidence of the validation/audit

In one implementation, the above response information does not contain any commercially sensitive information and/or data that is subject to Personal Data Protection Standards or Regulations. In spite of this, the Prism Service Rules are able to provide visibility into the potential impact (positive or negative) to the compliance posture of a regulated entity. This information shows the response to a specific item that is used in the Reverse Distillation Process in Stage Six (6) but is not, in and of itself, a determination, of compliance against anything. User Input is the Final Step of this Stage.

In one embodiment, Stage Five (5) is processed to Verify and Validate Customer Input. While this Stage is described in isolation, in reality, the User Input described in Stage Four (4) and the validation described within this stage occurs interactively both on a per-item basis and during review.
1. Response Validation.

When a User submits a response to an item, and sometimes before, the Prism Rules engine executes the required Rules for that Item and provides feedback to the user.

As an example, a User responds to a Prism Item with “Fully Complies”.

There was a Prism Rule that triggered when the Item was first presented to the User, where the Conditional Statement prevented the use of the “Partially Complies” response.

The first Rule that executes after the User input is a validation Rule that ensures a valid Response has been entered. Even though the Response was a pick list, in this example, the Rule executes and if an invalid Response of “Partially Complies” was somehow entered, bypassing the pick list, an Alarm would be triggered as this is a possible breach attempt and/or a misuse of the Interface . . . or simply an application Interface error, all of which need attention. However, the Answer in this instance is one of the possible valid options the Response is classed as valid and the User continues.

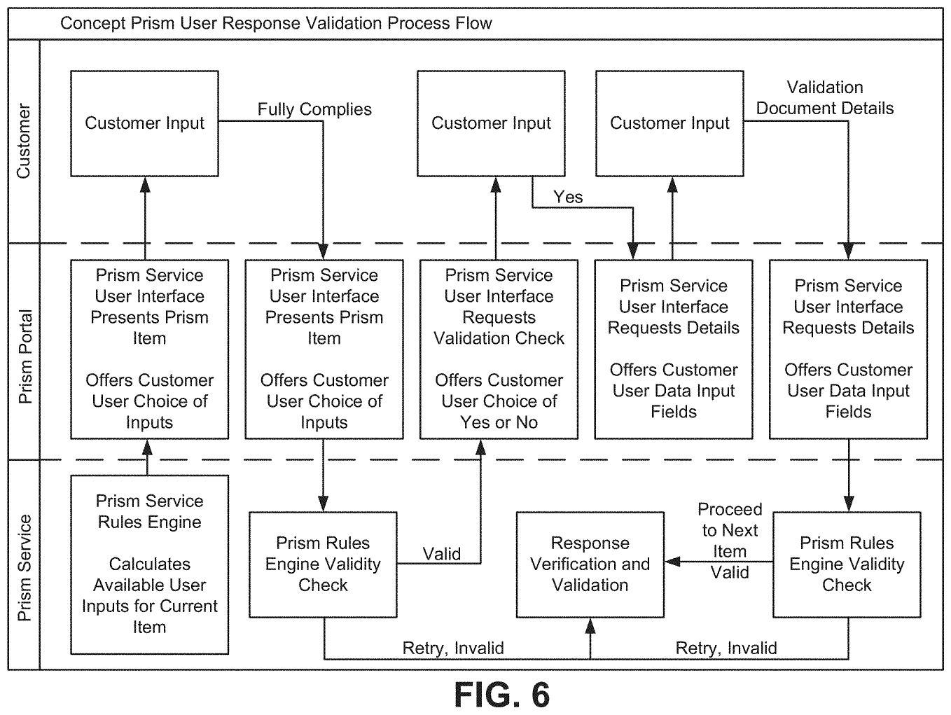

FIG. 6 presents a Validation Flow, in accordance with one embodiment. As a further example, the User provides input that the Response was “Externally Validated”.

After this input and the validation Rule triggers, it is found that the Assessment Date input is prior to the date of the document provided as containing the evidence. In this case, the User would be prompted to provide the Document Version/date—the same as that verified prior to the response being valid.
2. Response Assessment.

In one embodiment, after the Response is deemed valid it is assessed through the execution by the rules engine of the Conditional Statements in the Associations of this Item. The Rule mathematics determine if this valid response is incongruous with previous responses, either by this User or other Users associated with the same Customer.

Continuing with the Example above of a “Fully Complies”. The Rules determine there are no Responses within this section, by this User that are incongruous. A previous question is (transparent to the User) validated by the Response to “Fully Compliant”. There is, however, a Response within another section of the Prism Framework that has been assigned to a different User that is required by this Item and nominated as “Partially Complies”. In this case, the current User is not made aware of the conflict and resolution is prompted at a more senior Reviewer level, if the current response is not changed prior to submitting the section for review.

By way of example, the Rules ensure that if a Prism Items selected as false by User Input, then no Item that requires this Response to be true or partially true can be presented as anything but false (or partially true if that is not the only Item required to support the response). Where there is an inconsistency or incongruence that is outside the User Section, a Customer Reviewer Role can either Return or Override the Input. In the Override case, the Reviewer Response is also captured for Auditing.
3. Response Review and Submission.

After the user has responded to all items within the section assigned to him/her, or in the case of a smaller or flat organization structure the same user, he or she is presented with the ability to review the Responses.

The ‘New Customer On-boarding Process’, not contained within this document, requests that the Customer Nominate Frameworks and/or Regulations that are of particular interest either to them or their customers and even suppliers. As an example, a financial service provider would nominate the local jurisdiction's Regulatory Frameworks, Privacy Laws, possibly also the EU Privacy Laws (GDPR) and potentially the Card Payments Standards, PCI DSS.

The Assessment Rules both during submission, as well as during Review, highlight responses to Items that are associated to the Nominated Frameworks and draw attention to responses that are contrary to the Nominated Framework(s) Requirement. Because any given Item in the Prism Framework has the potential to be mapped to n number of External Frameworks, a specific Response could potentially impact multiple Frameworks.

Once the User has reviewed and Accepted/Approved all the Responses, all Actions captured with the Audit Trail details, the Response can be submitted to Prism. Once the Response to the Prism Framework is submitted by the Customer (Account Owner or Delegated User clicks ‘Submit’), this Stage ends.

In accordance with one embodiment, Stage Six (6) is processed to Reverse Distill Customer Responses.

Ultimately the purpose of Prism is fulfilled within this Stage. Prism exists to ensure a consistent, impartial and efficient method of providing Business Assurance Data to Customers. Stage One (1) and ultimately Stage Three (3) are where External Frameworks are consolidated to a single set of Items. However, Regulated Entities need to be able to determine their compliance posture against specific Regulations and Industry Frameworks, and the Prism Framework itself is not a Regulatory Framework. The Solution is the Prism Matrix. The Prism Rules can also reverse engineer the External Frameworks from the Prism Responses.
1. Map Responses to Published Templates.
   Many Frameworks provide Templates to contain Company Responses
2. For Frameworks nominated by the Customer, the Prism Rules execute in reverse, taking the data from the Prism Response and populating the Associated Framework Templates with the User-Provided Data.
3. For Frameworks where there is no Template, Prism provides a default template.

The Responses within these External Framework Templates are not a Score or a Determination, they are the basis for an Attestation by the Company of Compliance (or not) against the specified framework in a format ready for final review and submission to the Regulator or Framework Auditor. The Templates also enable a Regulated Entity to measure and determine their own Compliance Posture whether submitted to the Regulator or not, or in the case of a Supply Chain Review, the impact that a Supplier may have on their Regulatory Compliance Posture. While this is commonplace today, enabling this determination against n number of frameworks at once, is not. The visibility and auditability offered by the Prism Service to compliance owners also enables the inclusion of detailed sections in business contracts and can more readily hold Suppliers to account.

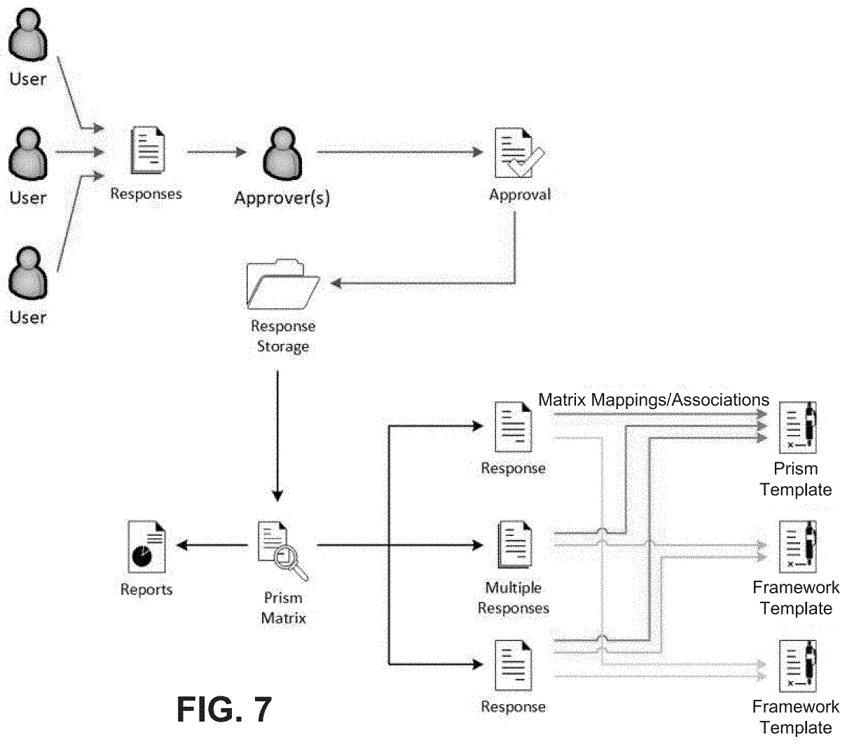

As depicted in FIG. 7, the Many to One Relationship Prism maintains with most External Framework Items, in accordance with one embodiment. While this does create, as in the example above, a significant list of comments and a potentially lower response score (“Partially” as opposed to “Fully” Compliant), the response is easily and readily justifiable to, in the case of the MAS TRM, a government Regulatory Body, and contains all the references if an Audit is Required.

Because the Principle Goal of the Prism Service is to simplify and bring efficiencies to the Business Assurance and Compliance Attestation Processes, the workload of Calculating the Best Response and Deduplicating and Correlating the Evidence is a Prism System task that, after the User Responses are finalized, completes processing in fractions of a second with full auditability and referencing, as opposed to a Human Task that can be long duration, opaque and potentially incomplete or in the worst case, lead to an overstated Attestation of Compliance.
4. Prism Service Outputs.

In one example embodiment, Formal Deliverables the Prism Service provides to Customers may include more or less of the following examples.
1. Prism Framework Response and Score.
2. Prism Service Maturity Score.
3. Populated Customer Selected Standard Framework Response Templates.
   a. Within the Framework Template, if one exists
4. Populated Customer Selected Regulatory Framework Response Templates
   a. Within the Framework Template, if one exists
5. Reporting.
   a. System Generated Reporting of Prism Maturity Score by Domain and Section
      i. This report also includes Supply Chain Maturity Scores for all Visible Vendors in the Supply Chain, with resulting impacts to “parent” suppliers.
   b. System Generated Reporting of Selected Framework
      i. Depending on the Framework Structure, this Report May or May Not be by Domain and Section
   c. Customer Generated Reports that can be a Mix of the above
6. Improvement Roadmap Presenting a Prioritized List of:
   a. Key Focus Areas that Achieve the Highest Increase in Selected Framework Compliance
   b. Key Focus Areas that Achieve the Highest Increase in Prism Framework Compliance and Maturity
7. Audit Trails supporting a per Item Response (per user/action) Tracking.

In order to facilitate these deliverables, the Customer Responses to the Prism Framework must be captured and stored. It should be noted that the data captured is Isolated per Customer. As Business Assurance is closely tied to Regulatory Compliance, the ability for Prism to enable customers to conform to Data Protection Regulations such as in jurisdiction storage and/or preventing access to data from outside the jurisdiction is paramount. Prism achieves this outcome for customers by first ensuring that all response data is isolated per customer and located in the location specified by the customer.

This need to isolate the customer data means that data is not able to be stored within the Prism Matrix or the Prism Framework, but requires a Dedicated Prism Response Store. The response store is structured to match the Prism Matrix for ease of reference and to enable customers wishing to leave the service a structured data set that is familiar.

The Prism Service provides several scores for the Response for multiple purposes, including Reporting.

Prism Scores Include, more or less of the following:
a. The “Item Score” which forms part of the “Prism Maturity Score” which is the Prism Framework Result.
   i. This is the only Assessment performed by the Prism Service.
b. The “Prism Maturity Score” is impacted by the perceived/calculated Accuracy of the Response and is impacted by Multiple Factors Including External Validation of the Result, the congruent (or not) nature of the response and available Auditing
c. The “Domain Score” is the Sum of all Item Scores for the Domain
d. The “Section Score” is the Sum of all the Domain Scores (and Items) within the Section
e. Completion Percentage
   i. How much of the Framework received User Responses.

External Scores Include, more or less of the following:
a. Framework Score
   i. This is not an Assessment
   ii. The Prism Service provides this Score to Consumers as in insight to what their inputs could yield if;
      1. The Responses and Approved and Authorized by the Prism Customer
      2. The information provided by the Prism Customer is Accurate
b. Completion Percentage
   i. How much of the Framework received Mapped Responses.

It should be noted that the External Framework Score is simply a calculation of the number of items that have been completed and to what level. They are not an assessment and the customer is and remains responsible for the accuracy of any information, regardless of the origin, being submitted to a Regulator or Framework Assessor.

It should also be noted that these scores, whilst executed by the Rules Engine, they are not Deductive Reasoning but simple arithmetic. The result from the example below represents a “Domain Score”.

$$( \frac{( Sum of all Responses and Multipliers )}{( Sum of all the Maximum Possible Score for Each Item )} ) \times 100 = Result \%$$

The Response Scoring and Reporting also offers several depictions of the Results. Such as:

| | |
|---|---|
| Not Applicable | 23 |
| Not Compliant | 62 |
| Partially Compliant | 287 |
| Fully Compliant | 139 |
| Total: | 511 |

In the above Example we can see the result of a Report on the number of responses by “Type” against a given framework. These types of reporting insights are to aid the Prism Customer in identifying areas that require focus to improve total compliance and maturity scores. The Prism Roadmap is essentially a prebuilt model for that outcome. By way of example, a highly Mature Organization will be able to provide a high level of confidence to the consuming organization that the consuming organization's regulatory compliance posture will not be negatively impacted by the use of said supplier.

In addition to the Framework Templates, Prism also offers a roadmap to increase compliance and maturity to Customers. The same Rules Execution process also highlights Prism Items that map to many (or just one) Nominated Framework. The Prism Matrix mathematics can model the Outcome, should a Specific Response change in a positive way. By placing these Items in a Roadmap, Prism enables Customers to identify key functions with their technology partners and drive business maturity and compliance in a structured, efficient and targeted manner. This type of Data Driven insights are very difficult if not impractical to reproduce with the current human resource intensive processes.

In one embodiment, a confidence score for an entity can be calculated and maintained as an internal score that is not exposed to consumers of the Prism Service. The confidence score, however, is used to negatively impact the “Maturity Score” which is the Calculated Score for responses to the Provisioned Framework. A response to the Provisioned Framework with lots of conflicting responses/incongruencies will have a lower Maturity Score. In another embodiment, Confidence is not a score, it is buyer or consumer confidence. By way of example, a consumer of a Service provided by a Vendor with a High Maturity Score is Higher than a Vendor with a lower score against the Provisioned Framework.

As depicted in the example of FIG. 1, the Prism Framework Structure enables the delivery of Reporting by Section and Domain. The Prism Service does contain several pre-built reports and the roadmap includes one example. However, Prism Customers are also able to create, maintain and execute bespoke reports as required.

The Process described in the preceding sections articulates examples of the Framework Adoption by the Prism Service through to Prism Customer Utilization. One example role of Prism is to use Technology to create efficiencies in gathering, tracking and responding to requests for Business Assurance Data from Regulated Entities and to simplify the Population of Response Templates for Industry and Regulatory Frameworks. However, the Accuracy of any Framework Submission or the Validity of any Business Assurance Data, and/or the use of that Business Assurance Data by an organization to determine any impact to their Compliance Posture is not the Responsibility of Prism and always resides with the consuming Organization(s). Prism Seeks to increase user confidence through making the process of identifying, documenting, tracking, visualizing and providing Business Assurance Data simple and efficient.

Embodiments of the present invention may be practiced with various computer system configurations including servers, cloud systems, hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention could employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer or storage in cloud systems. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. The computer readable medium can also be distributed over a network-coupled computer system so that the computer readable code is stored and executed in a distributed fashion. The method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method for collecting and processing business assurance data using a Software as a Service (SaaS) system, comprising:
receiving a request to access the SaaS system from a user;
providing an interface by the SaaS system to a remote device of the user, wherein the business assurance data is represented as items to be filled in via the interface of a provisioned framework, the items received via the provisioned framework are mapped and filled into a plurality of target frameworks; and
generating a provisioned template representing items filled into the provisioned framework and generating a plurality of target templates corresponding to each of the target frameworks;
wherein said items filled in via the interface of the provisioned framework are automatically filled into the plurality of target frameworks.

2. The method of claim 1, wherein said mapping implements a matrix to program item relationships that enable the mapping of said items from the provisioned framework to each of the target frameworks.

3. The method of claim 2, further comprising,
executing a rules engine for accessing the matrix, the rules engine is configured to process the item relationships programmed into the matrix.

4. The method of claim 3, wherein processing the item relationships programmed into the matrix include application of deductive reasoning computations.

5. The method of claim 3, wherein the relationships programmed into the matrix further include deductive reasoning logic, and said rules engine constructs execution of the deductive reasoning logic to test if items provided are true or false.

6. The method of claim 4, wherein said deductive reasoning computations operate on a true/false test that requires a question to solve before said deductive reasoning computations start by said rules engine.

7. The method of claim 4, wherein said deductive reasoning computation does not determine whether an item provided to the provisioned framework is correct, said provided response is instead a question to be solved or validated.

8. The method of claim 1, wherein the mapping is one of a direct mapping between an item of the provisioned framework to an item of a target framework, or the mapping is one of an indirect mapping between an item of the provisioned framework mapped to another item of the provisioned framework and then mapped to a target framework.

9. The method of claim 1, wherein said mapping implements a matrix to program item relationships that enable the mapping of said items from the provisioned framework to each of the target frameworks, and wherein for each item filled into the provisioned framework, access is made to the matrix that contains deductive reasoning logic, said access is by a rules engine that processes one or more tests using the deductive reasoning logic on the items filled into the provisioned framework before being filled into one or more of the plurality of target frameworks,
wherein items entered into the plurality of target frameworks enable generation of respective target templates representing the items of the target frameworks.

10. The method of claim 9, wherein said deductive reasoning logic that is part of the matrix is separate from execution of the deductive reasoning logic by the rules engine, such that modifications to the deductive reasoning logic is independent of execution of the rules engine.

11. The method of claim 10, wherein the deductive reasoning logic of the matrix is static and separate from execution by the rules engine, wherein the matrix being static enables changes upon an approval process and is not modifiable by the rules engine.

12. The method of claim 2, wherein the matrix is a database that contains said item relationships, said item relationships further include item associations.

13. The method of claim 12, wherein item associations in the matrix are processed by tests executed by a rules engine.

14. A method for collecting and processing business assurance data using a Software as a Service (SaaS) system, comprising:
receiving a request to access the SaaS system from a user;
providing an interface by the SaaS system to a remote device of the user, wherein herein the business assurance data is represented as items to be filled in via the interface of a provisioned framework, the items received via the provisioned framework are mapped and filled into of a target framework, wherein said mapping implements a matrix that has validated item relationships that enable the mapping of said items from the provisioned framework to said target framework, and wherein for each item filled into the provisioned framework, access is made to the matrix that contains deductive reasoning logic, said access is by a rules engine that processes one or more tests using the deductive reasoning logic of the matrix on the items filled into the provisioned framework before items are filled into the target framework; and
generating a provisioned template representing items filled into the provisioned framework and generating a target template representing items automatically filled into the target framework.

15. The method of claim 14, wherein additional target frameworks are processed by the SaaS system, such that said items entered into the provisioned framework are automatically filled into said additional target frameworks using said matrix that has validated item relationships between said provisioned framework and each of said additional target frameworks.

16. The method of claim 15, further comprising,
generating target templates for each of said additional target frameworks.

17. The method of claim 14, wherein said deductive reasoning logic when executed operates on a true/false test that requires a question to solve before a deductive reasoning computation starts using said rules engine.

18. The method of claim 14, wherein said deductive reasoning computation does not determine whether an item provided to the provisioned framework is correct, without providing a question to be solved.

19. A method for collecting and processing business assurance data using a Software as a Service (SaaS) system, comprising:
receiving a request to access the SaaS system from a user;
providing an interface by the SaaS system to a remote device of the user, wherein herein the business assurance data is represented as items to be filled in via the interface of a provisioned framework, the items received via the provisioned framework are mapped and filled into of a plurality of target frameworks, wherein said mapping implements a matrix that has validated item relationships that enable the mapping of said items from the provisioned framework to each of said plurality of target frameworks, and wherein for each item filled into the provisioned framework, access is made to the matrix that contains deductive reasoning logic, said access is by a rules engine that processes one or more tests using the deductive reasoning logic of the matrix on the items filled into the provisioned framework before items are filled into one or more of the plurality of target frameworks; and
generating a provisioned template representing items filled into the provisioned framework and generating a plurality of target templates representing items automatically filled into the target framework;
wherein each of said target templates include a reporting of a total number of items populated with responses filled into the provisioned framework by the user and a breakdown of said responses by type;
wherein the user is a vendor providing said items related to a service or product, and said maturity score provides information related to quality of said items responses provided by the vendor.

20. The method of claim 19, wherein said deductive reasoning logic when executed operates on a true/false test that requires a question to solve before a deductive reasoning computation starts using said rules engine, and said deductive reasoning computation does not determine whether an item provided to the provisioned framework is correct, said provided response is instead a question to be solved or validated.
